(19) United States
(12) Patent Application Publication
(10) Pub. No.: US 2023/0083742 A1
(43) Pub. Date: Mar. 16, 2023

(54) ALL-SOLID-STATE BATTERY HAVING ELECTROLYTE-FREE ELECTRODE, AND METHOD AND SYSTEM OF EVALUATING ION-CONDUCTING BINDER USING THE SAME

(71) Applicant: Electronics and Telecommunications Research Institute, Daejeon (KR)

(72) Inventors: Dong Ok SHIN, Daejeon (KR); Young Gi LEE, Daejeon (KR); Jae Cheol CHOI, Daejeon (KR); Ju Young KIM, Daejeon (KR); Seok Hun KANG, Daejeon (KR); Young Sam PARK, Daejeon (KR)

(73) Assignee: Electronics and Telecommunications Research Institute, Daejeon (KR)

(21) Appl. No.: 17/901,019

(22) Filed: Sep. 1, 2022

(30) Foreign Application Priority Data
Sep. 14, 2021 (KR) 10-2021-0122758
Jun. 9, 2022 (KR) 10-2022-0069921

(51) Int. Cl. H01M 4/62; H01M 10/0525; H01M 10/44; H01M 10/48

(52) U.S. Cl. CPC H01M 4/622; H01M 10/0525; H01M 4/625; H01M 10/44; H01M 10/48

(57) ABSTRACT

An all-solid-state battery for an ion-conducting binder evaluation system for a secondary battery may comprise: an electrode manufactured with an electrode composition, which includes electrode active materials and a binder, so that ion transport in the electrode is dependent on a mechanism of ion diffusion between the electrode active materials by excluding an electrolyte component from the electrode; a counter electrode disposed to face the electrode; and a solid electrolyte layer disposed between the electrode and the counter electrode, wherein a pore density of the electrode, which is an electrolyte-free electrode, is less than or equal to 15% of an electrode bulk density.

### CROSS-REFERENCE TO RELATED APPLICATIONS

This application claims priority to Korean Patent Applications No. 10-2021-0122758, filed on Sep. 14, 2021, and No. 10-2022-0069921, field on Jun. 9, 2022, with the Korean Intellectual Property Office (KIPO), the entire contents of which are hereby incorporated by reference.

### BACKGROUND

### 1. Technical Field

Exemplary embodiments of the present disclosure relate in general to an electrolyte-free electrode, an all-solid-state battery, and an ion-conducting binder evaluation system, and more particularly, to an ion-conducting binder evaluation system using an all-solid-state battery in order to reliably evaluate the performance of an ion-conducting binder for a secondary battery, an electrolyte-free electrode for the same, a manufacturing method of the electrolyte-free electrode, and an all-solid-state battery including the electrolyte-free electrode.

### 2. Related Art

Secondary batteries, especially lithium secondary batteries using lithium ions, are being used not only as power sources of small electronic devices, but also as medium- and large-sized power sources in energy storage systems (ESS) and electric vehicles, whose sales market is recently growing, due to excellent energy density, high reliability, and lifespan characteristics thereof.

Meanwhile, the performance of devices using the lithium secondary batteries depends on the improvement of energy density, and thus the development of high-capacity, high-density, and high-performance secondary batteries is required. Accordingly, in order to satisfy this, new secondary battery materials such as positive electrode active materials, negative electrode active materials, electrolytes, separators, and binders with improved physical properties and performance are being developed.

Meanwhile, in the case of the lithium secondary batteries, there is a problem, in which a current collector of an electrode is detached or an electron/ion movement path in the electrode is cut off due to continuous electrode expansion and contraction during battery operation, which is a cause of capacity degradation or failure. Accordingly, the development of a high-performance binder for solving this problem is required.

Further, various studies and developments are in progress to respond to environmental issues and reduce manufacturing costs of battery electrodes. For example, various approaches for using an electrode for lithium secondary batteries converted from an existing organic binder system to an aqueous binder system are being researched and developed.

Basically, binders are materials requiring high cohesion, which maintains strong binding between active material particles, and strong adhesion between the binder and a current collector. However, a typical binder material is an inert binder focusing on cohesive and adhesive properties, and inhibits electron or ion movement between active material particles.

As conventional binder studies, studies on an electron-conducting binder represented by a poly(3,4-ethylenedioxythiophene):poly(styrene sulfonate) (PEDOT:PSS) compound have been mainly conducted. In the case of conventional binder studies, the main purpose is to secure high energy density by securing electron conductivity in an electrode made of an oxide-based positive electrode material or a high-capacity silicon-based material to reduce the necessity of a carbon-type conductive material.

Meanwhile, in the case of studies on ion-conducting binders, PEDOT:PSS-based multi-component binders, and materials such as lithium polyacrylate (LiPAA), lithium carboxymethyl cellulose (Li-CMC), and the like, which have secured both electron conductivity and ion conductivity, have been developed, and secondary battery electrodes based on these also showed improved performance.

However, as a result of confirming the performance of an electrode, which includes a conventional ion-conducting binder, in a liquid electrolyte-based lithium-ion battery system, there is a limit to purely evaluating the performance of the ion-conducting binder for ion conductivity in the electrode in a liquid electrolyte-based battery because there are many considerations as follows, first, compatibility between a liquid electrolyte and the electrode or binder, second, an effect due to the formation of a solid electrolyte interphase (SEI) layer, third, the wettability of the liquid electrolyte in the electrode, and fourth, the thermal or chemical stability of the liquid electrolyte.

Considering that minimizing the content of the binder included in the electrode to maximize the energy density is an important electrode configuration strategy and that a small amount of binder content greatly influences overall battery performance, it is required to establish a highly reliable evaluation system for the development of high-performance binders, particularly high-performance ion-conducting binders.

### SUMMARY

Accordingly, the present disclosure is provided to substantially obviate one or more problems due to limitations and disadvantages of the related art. Exemplary embodiments of the present disclosure are directed to providing an electrolyte-free electrode including only an active material, which has excellent electron conductivity and in which ion diffusion is possible through contact between particles, and an ion-conducting binder, and a manufacturing method of the same.

Other exemplary embodiments of the present disclosure are directed to providing an all-solid-state battery including the above-described electrolyte-free electrode.

Still other exemplary embodiments of the present disclosure are directed to providing a system for evaluating ion conductivity of an ion-conducting binder in an electrode for a secondary battery. That is, still other exemplary embodiments of the present disclosure are directed to providing a system for effectively evaluating the ion conductivity of an ion-conducting binder in an electrolyte-free electrode of an all-solid-state battery using the electrolyte-free electrode in which an electrolyte component is completely excluded from the electrode, unlike a conventional general secondary battery or all-solid-state battery having an electrolyte component in an electrode. In other words, still other exemplary embodiments of the present disclosure are directed to providing a system capable of evaluating the contribution of the ion-conducting binder in the electrode with high reliability by performing electrochemical and battery evaluation using the all-solid-state battery including the electrolyte-free electrode.

According to a first exemplary embodiment of the present disclosure, an all-solid-state battery for an ion-conducting binder evaluation system for a secondary battery may comprise: an electrode manufactured with an electrode composition, which includes electrode active materials and a binder, so that ion transport in the electrode is dependent on a mechanism of ion diffusion between the electrode active materials by excluding an electrolyte component from the electrode; a counter electrode disposed to face the electrode; and a solid electrolyte layer disposed between the electrode and the counter electrode, wherein a pore density of the electrode, which is an electrolyte-free electrode, is less than or equal to 15% of an electrode bulk density.

The binder may include an ion-conducting binder or a non-ion-conducting binder.

The ion-conducting binder may include an ion-conducting component and a functional group in a polymer structure.

The ion transport in the electrode may be performed through a diffusion path through contact between the electrode active materials, and an additional path through the ion-conducting binder, wherein the additional path may be generated by the ion-conducting binder.

A material of the electrode active material may include one selected from a negative electrode material coated with an electron-conducting layer, including graphite, hard carbon, soft carbon, a carbon nanotube, graphene, redox graphene, a carbon fiber, amorphous carbon, a silicon-carbon composite (SiC), or a carbon layer, and a mixed composition thereof.

An electron conductivity of the electrode active material may be greater than or equal to 2 S/cm.

A composition ratio of the electrode active material and the binder may be selected in a range from 90:10 to 99.5:0.5 on the basis of a weight ratio.

According to a second exemplary embodiment of the present disclosure, a method of evaluating an ion-conducting binder for a secondary battery, which is performed by an ion-conducting binder evaluation system, may comprise: disposing a first all-solid-state battery, which includes a first electrode manufactured with a first electrode composition including an electrode active material and an ion-conducting binder, a counter electrode disposed to face the first electrode, and a solid electrolyte layer disposed between the first electrode and the counter electrode, at a specific position in the evaluation system; setting an evaluation condition for a signal applied to the first all-solid-state battery or a provided environment; and measuring electrochemical and battery characteristics of the first all-solid-state battery according to the evaluation condition.

The method may further comprise: disposing a second all-solid-state battery, which includes a second electrode manufactured with a second electrode composition including the electrode active material and a non-ion-conducting binder, a counter electrode disposed to face the second electrode, and a solid electrolyte layer disposed between the second electrode and the counter electrode, at a specific position in the evaluation system; and measuring electrochemical and battery characteristics of the second all-solid-state battery according to the evaluation condition.

The method may further comprise evaluating the performance of the ion-conducting binder by comparing the electrochemical and battery characteristics of each of the first all-solid-state battery and the second all-solid-state battery.

In the evaluating of the performance of the ion-conducting binder, the relative performance of the ion-conducting binder may be evaluated on the basis of one from among a comparison of the time required for fully charging, a comparison of charge capacity according to a change in charge/discharge rate, a comparison of internal resistance of the all-solid-state battery, a comparison of charge capacity according to an electrode active material loading level, and a comparison of charge capacity according to driving temperature.

The measuring of the electrochemical and battery characteristics may include measuring the time required for fully charging, wherein the measuring of the time required for fully charging may be performed in the order of constant current-constant voltage (CC-CV) mode charging and CC mode discharging, wherein a maximum lithium intercalation behavior may be induced by setting a charge/discharge voltage to a range of 0.01 V to 2 V and a cut-off current during the CC-CV mode charging at a predetermined temperature to a value between 1/5 and 1/10.

The measuring of the electrochemical and battery characteristics may include measuring the charge capacity according to the change in charge/discharge rate, wherein, in the measuring of the charge capacity according to the change in charge/discharge rate, the charge/discharge rate of CC-CV mode charging may be adjusted to 0.05 C to 10 C.

The measuring of the electrochemical and battery characteristics may include measuring the internal resistance of the all-solid-state battery, wherein, in the measuring of the internal resistance, a surface resistivity inside an all-solid-state battery cell at a specific temperature may be measured while applying an alternating current (AC) impedance in a range of 10⁻¹ Hz to 10⁵ Hz using a frequency response analyzer.

The measuring of the electrochemical and battery characteristics may include measuring the charge capacity according to the electrode active material loading level, wherein, in the measuring of the charge capacity according to the electrode active material loading level, a maximum charge amount and a capacity implementation rate of the electrode may be measured while adjusting the active material loading level of the electrode within 2 to 20 mg/cm².

The measuring of the electrochemical and battery characteristics may include measuring the charge capacity according to the driving temperature, wherein the measuring of the charge capacity according to the driving temperature may be performed by setting a cut-off current to 1/10 while controlling a charging rate to 0.1 C to 1 C through CC-CV mode charging and CC mode discharging at 0.01 V to 2 V.

The ion-conducting binder may be one selected from among a poly(3,4-ethylenedioxythiophene):poly(styrene sulfonate) (PEDOT:PSS)-based multi-component binder, lithium polyacrylate (LiPAA), and lithium carboxymethyl cellulose (Li-CMC), or a combination thereof, and a material of the electrode active material may include one selected from a negative electrode material coated with an electron-conducting layer, including graphite, hard carbon, soft carbon, a carbon nanotube, graphene, redox graphene, a carbon fiber, amorphous carbon, a silicon-carbon composite (SiC), or a carbon layer, and a mixed composition thereof.

According to a third exemplary embodiment of the present disclosure, an ion-conducting binder evaluation system configured to evaluate the performance of an ion-conducting binder for a secondary battery may comprise: a driving unit configured to apply a signal for performance evaluation to a first all-solid-state battery located at a predetermined position of evaluation system hardware, wherein the first all-solid-state battery includes a first electrode composition composed of an electrode active material and an ion-conducting binder, a counter electrode disposed to face a first electrode formed of the first electrode composition, and a solid electrolyte layer between the first electrode and the counter electrode; an evaluation condition setting unit configured to adjust an evaluation condition for an environment provided to the first all-solid-state battery through a signal applied to the first all-solid-state battery or the evaluation system hardware from the driving unit; and a measuring unit connected to the first all-solid-state battery and configured to measure electrochemical and battery characteristics of the first all-solid-state battery according to the evaluation condition.

The driving unit may apply a signal for performance evaluation to a second all-solid-state battery located at a predetermined position of the evaluation system hardware, the second all-solid-state battery may include a second electrode composition composed of the electrode active material and a non-ion-conducting binder, a counter electrode disposed to face a second electrode formed of the second electrode composition, and a solid electrolyte layer between the second electrode and the counter electrode, and the measuring unit may be connected to the second all-solid-state battery and measures electrochemical and battery characteristics of the second all-solid-state battery according to the evaluation condition.

The ion-conducting binder evaluation system may further comprise a comparison unit configured to compare the electrochemical and battery characteristics of each of the first all-solid-state battery and the second all-solid-state battery on the basis of measurement information of the measuring unit, wherein the measurement information may include at least one piece of information selected from among the time required for fully charging, charge capacity according to a change in charge/discharge rate, internal resistance of the all-solid-state battery, charge capacity according to an electrode active material loading level, and charge capacity according to driving temperature for each of the first all-solid-state battery and the second all-solid-state battery.

The ion-conducting binder evaluation system may further comprise a binder evaluation unit configured to evaluate the performance of the ion-conducting binder on the basis of a comparison result of the comparison unit.

According to the present disclosure, it is possible to provide an all-solid-state battery electrode using an electrode which completely excludes an electrolyte component in the electrode and includes an active material, which has excellent electron conductivity and in which a mechanism of ion diffusion through contact between particles is possible, and an ion-conducting binder, and an evaluation system configured to evaluate the electrochemical and battery performance of a secondary battery connected to the all-solid-state battery electrode.

Specifically, a binder in an electrode is a component constituting the electrode by increasing the binding of active material particles and maintaining strong adhesion between the active material particles er and a current collector. In this case, since the binder binds the particles to each other while surrounding the particles, the binder located between the particles further inhibits ion transport between the particles that exhibit an essentially slow behavior, thereby causing interface resistance. In the case of an ion-conducting binder, the interface resistance can be reduced by enabling ion transport between the particles, and such an effect can be compared more clearly when there is no electrolyte component in the electrode.

In particular, when an electrode from which an electrolyte component is completely excluded is used as an all-solid-state battery electrode, ion transport in the electrode is performed purely through diffusion through inter-particle contact, and thus, the difference between a non-ion-conducting binder and the ion-conducting binder can be easily distinguished. This is because the binder constitutes the electrode while surrounding the active material particles and thus ion transport at an interface between the particles is important. That is, in the all-solid-state battery, the performance of the ion-conducting binder in the electrode can be effectively evaluated through the mechanism that lithium ions are supplied from an intermediate solid electrolyte layer between both electrodes and move into the electrode through inter-particle diffusion during charging.

Further, with an electrode with a high active material loading level, and in a fast charge/discharge driving condition or low temperature driving condition, the contribution of an ion-conducting binder in implementing a high-performance electrode can be more reliably evaluated as compared to that of a non-ion-conducting binder.

As described above, according to the present disclosure, the performance of an ion-conducting binder and a non-ion-conducting binder can be effectively evaluated by comparing lithium ion conductivity in an electrode. In addition, the ion conductivity of the binder can be reliably evaluated through an ion-conducting binder evaluation system for a secondary battery, and a new ion-conducting binder required for developing an electrode with high energy density and high-speed charging and discharging can be developed on the basis of the evaluation.

### BRIEF DESCRIPTION OF DRAWINGS

FIG. 1A is a conceptual diagram of an all-solid-state battery including an electrolyte-free electrode according to exemplary embodiments of the present disclosure.

FIG. 1B is a front view of the all-solid-state battery of FIG. 1A.

FIG. 1C is a partially enlarged view of the all-solid-state battery of FIG. 1B.

FIG. 2 is a view for describing a synthetic route of a binder for an electrolyte-free electrode that can be employed in the all-solid-state battery of FIG. 1.

FIG. 3 is a schematic cross-sectional view of an all-solid-state battery according to exemplary embodiments of the present disclosure.

FIG. 4A is a conceptual view of a lithium-ion battery using an electrode impregnated in a liquid electrolyte of a comparative example.

FIG. 4B is a front view of the lithium-ion battery of FIG. 4A.

FIG. 5A is a view for describing the flow of ions in the electrode during a charging process of the all-solid-state battery of the present exemplary embodiment.

FIG. 5B a view illustrating the flow of ions in the electrode during the charging process of the all-solid-state battery of a comparative example.

FIG. 6A is a time versus voltage graph illustrating charging and discharging of the ion-conducting binder-based electrode of the present exemplary embodiment.

FIG. 6B is a time versus voltage graph illustrating charging and discharging of the non-ion-conducting binder-based electrode of the comparative example.

FIG. 7 is a graph illustrating changes in areal capacity according to a charging time in the all-solid-state batteries respectively using the ion-conducting binder-based electrode of the present exemplary embodiment and the non-ion-conducting binder-based electrode of the comparative example.

FIG. 8 is a graph comparing and illustrating changes in areal capacity according a charge/discharge rate in the all-solid-state batteries respectively using the ion-conducting binder-based electrode of the present exemplary embodiment and the non-ion-conducting binder-based electrode of the comparative example.

FIG. 9 is a graph comparing and illustrating internal resistances of the all-solid-state batteries respectively using the ion-conducting binder-based electrode of the present exemplary embodiment and the non-ion-conducting binder-based electrode of the comparative example.

FIG. 10 is a graph illustrating areal capacities, which are measured at different loading levels of the electrode at a charge/discharge rate of 0.1 C and in a temperature atmosphere of 60° C. for the all-solid-state batteries respectively using the Li-CMC binder-based electrode of the present exemplary embodiment and the Na-CMC binder-based electrode of the comparative example, and capacity utilizations according thereto.

FIG. 11 is a graph comparing and illustrating voltages and sheet resistances of the all-solid-state batteries, which are charged and discharged at room temperature under 0.1 C conditions, respectively using the Li-CMC binder-based electrode of the present exemplary embodiment and the Na-CMC binder-based electrode of the comparative example. In the test, the maximum theoretical capacity was 2.4 mAhcm⁻² and the charging and discharging proceeded in a voltage range of 0.01 V to 2 V.

FIG. 12 is a schematic block diagram of an ion-conducting binder evaluation system for a secondary battery according to another exemplary embodiment of the present disclosure.

FIG. 13 is a block diagram of a main configuration of the ion-conducting binder evaluation system of FIG. 12.

FIG. 14 is a detailed block diagram of a partial configuration of the ion-conducting binder evaluation system of FIG. 13.

### DETAILED DESCRIPTION OF THE EMBODIMENTS

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

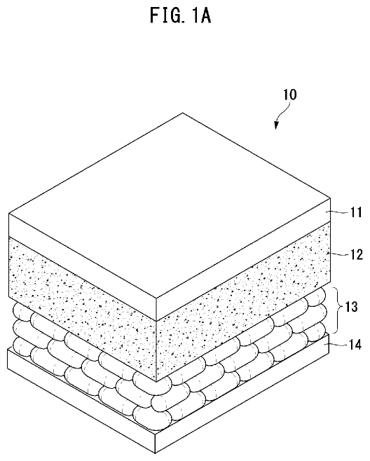

FIG. 1A is a conceptual diagram of an all-solid-state battery including an electrolyte-free electrode according to exemplary embodiments of the present disclosure. FIG. 1B is a front view of the all-solid-state battery of FIG. 1A. FIG. 1C is a partially enlarged view of the all-solid-state battery of FIG. 1B.

Referring to FIG. 1A, an all-solid-state battery (ASSB) 10 may include a first electrode 11, a solid electrolyte layer 12, an electrolyte-free electrode 13, and a current collector 14. The electrolyte-free electrode 13 may have a stacked structure between the current collector 14 and the solid electrolyte layer 12. The first electrode 11 may be formed of lithium (Li) metal, and the electrolyte-free electrode 13 may be formed by coating an electrode composition on the current collector 14. Such an electrode structure of the electrolyte-free electrode 13 is constituted only by an active material and a binder and completely excludes an electrolyte component.

The first electrode 11 may be referred to as a “counter electrode” as a counter electrode of the electrolyte-free electrode 13, and may be formed of Li metal or the like, and the electrolyte-free electrode 13 is an electrode from which an electrolyte component is completely excluded, may be manufactured through an aqueous process using an active material and a binder.

A manufacturing process of the all-solid-state battery 10 will be described in more detail as follows.

First, in preparation of materials, as electrode active materials for manufacturing the electrode from which an electrolyte component is completely excluded, one or more selected from a high-capacity negative electrode material coated with an electron-conducting layer, such as, graphite, hard carbon, soft carbon, a carbon nanotube, graphene, redox graphene, a carbon fiber, amorphous carbon, a silicon-carbon composite (SiC), and carbon, and a mixed composition thereof may be used as a material that is advantageous for mechanical deformation and has a high electron conductivity of 2 S/cm or more. The negative electrode material may include silicon or silicon oxide (SiOx), tin (Sn), cobalt oxide (CoOₓ), iron oxide (FeOₓ), and a combination thereof.

As an ion-conducting binder material for manufacturing the electrode from which an electrolyte component is completely excluded, a structure in which a functional group containing a hydroxyl group, carboxylic acid, sulfonic acid, phosphoric acid, or monovalent metal present in a structure of a cellulose derivative polymer is substituted with lithium may be used.

As an example, a cellulose derivative including lithium may be used as the ion-conducting binder material. The cellulose derivative may include one selected from among cellulose, methyl cellulose, ethyl cellulose, butyl cellulose, hydroxypropyl cellulose, cellulose nitrate, cellulose acetate, cellulose acetate propionate, cellulose acetate butyrate, carboxymethyl cellulose (CMC), xanthan gum, pectin, guar gum, dextran, and a combination thereof.

Further, the ion-conducting binder material may include one selected from among polytetrafluoroethylene, polyvinylidene fluoride, polyvinylidene fluoride-hexafluoropropylene, poly(ethylene oxide), polyacrylonitrile, polyacrylic acid, styrene-butadiene, nitrile-butadiene rubber, butadiene rubber, and a combination thereof containing lithium or lithium salt.

That is, as the ion-conducting binder material, a lithium-substituted cellulose derivative and a polymer binder material containing lithium or lithium salt may be used alone or in combination. The lithium salt constituting the polymer binder containing lithium salt may include one selected from among LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, LiFSI, LiTFSI, LiBETI, LiBPB, LiCTFSI, LiTDI, LiPDI, and a combination thereof.

Next, as an electrode manufacturing process, an electrode, from which an electrolyte component is completely excluded, that is, the electrolyte-free electrode 13, is manufactured on the current collector 14 by a slurry-based coating method based on a composition composed of only an electrode active material and a binder. More specifically, after the binder is dissolved in a specific solvent, the binder solution is uniformly mixed with the electrode active material to form an electrode slurry. At this point, a composition ratio of the active material and the binder may be selected between 90:10 and 99.5:0.5, and preferably, between 97:5 and 99:1 on the basis of a weight ratio.

Next, the electrode slurry is coated as a thick film on the current collector 14. For the slurry coating, various methods, such as, a gravure coater method, a small-diameter gravure coater method, a reverse roll coater method, a transfer roll coater method, a kiss coater method, a dip coater method, a knife coater method, an air doctor blade coater method, a blade coater method, a bar coater method, a die coater method, a screen printing method, and a spray coating method may be applied to a thick coating process. After the electrode slurry is coated on the current collector 14, the solvent may be removed through a high-temperature drying process and a vacuum drying process.

A thickness t1 of the electrolyte-free electrode 13 may be controlled in a range of several micrometers to several hundred micrometers in the process of the slurry-based coating process. In addition, the drying may be performed under a temperature atmosphere of 80° C. to 120° C. and a vacuum atmosphere of 10 hours to 20 hours to satisfy a residual solvent content of several ppm or less. Next, a pressing process is performed at a pressure of 100 MPa to 200 MPa to improve contact between the active material particles coated on the current collector 14. In order to reduce porosity, a hot-press process in a temperature atmosphere of 100 to 300° C. may be applied. A pore density of the electrode after being pressed is preferably less than or equal to about 15%, and more preferably less than or equal to 5%.

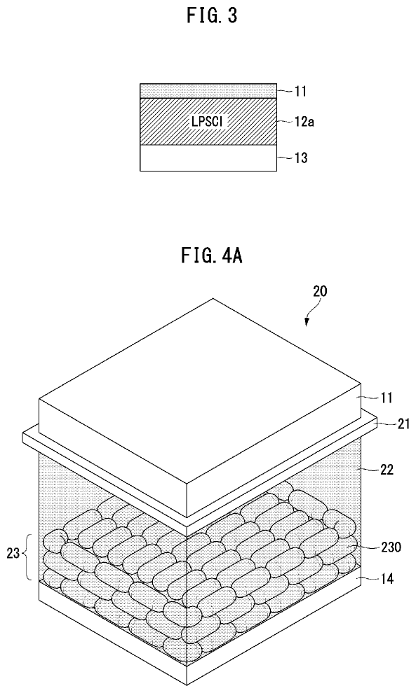

The manufactured electrolyte-free electrode 13 may refer to the current collector 14 and the electrode composition coated on the current collector 14 in a broad sense. The electrode composition coated on the current collector 14 may have a form in which granular unit electrodes 130 (see FIG. 1B) are stacked. Thus, as shown in FIG. 1B, the thickness t1 of the electrolyte-free electrode 13 of the present exemplary embodiment in a stacking direction may be definitely less than a thickness t2 (see FIG. 4B) of an electrolyte-free electrode 23 of a comparative example to be described below.

Referring to FIGS. 1A and 1B again, in order to utilize the electrolyte-free electrode 13 of the present exemplary embodiment as an electrode for the all-solid-state battery 10, in the all-solid-state battery 10, a solid electrolyte may be manufactured in the form of a layer and used as an intermediate electrolyte layer of the all-solid-state battery 10. This solid electrolyte may be referred to as a solid electrolyte layer 12.

As a material of the solid electrolyte layer 12, an oxide-based, phosphate-based, sulfide-based, or polymer-based solid electrolyte may be used and may be applied alone or in a mixed form. In the case of an inorganic-based solid electrolyte, the solid electrolyte layer 12 may be manufactured as a layer of a predetermined thickness through a cold or high-temperature sintering process. The predetermined thickness may be 30 μm to 2000 μm. In addition, in the case of a composite electrolyte of a polymer electrolyte or an inorganic-based solid electrolyte, the solid electrolyte layer 12 may be formed as a layer of a predetermined thickness through a coating method after being prepared as a slurry using a specific solvent.

Here, the predetermined thickness may be 30 μm to 1000 μm. In addition, in order to increase mechanical strength, the solid electrolyte layer 12 may be manufactured in a form including a polymer binder or an organic or inorganic scaffold.

The oxide-based solid electrolyte as the material of the solid electrolyte layer 12 may be selected from materials having a garnet structure with a composition of Li_{7-3x+y-z}AₓLa_{3-y}B_{y}Zr_{2-z}C_{z}O₁₂ (where A═Al, Ga; B═Ca, Sr, Ba; C═Ta, Nb, Sb, Bi). In particular, for Li₇₋ₓAₓLa₃Zr₂O₁₂, a material doped with a doping element such as aluminum (Al), gallium (Ga), or the like at a ratio of 0 mol to 0.3 mol on a Li site, and/or a material doped with a doping element such as niobium (Nb), tantalum (Ta), or the like at a ratio of 0 mol to 0.3 mol on a Zr site. In addition, as the oxide-based solid electrolyte, Li₃ₓLa_{(2/3)-x□(1/3)-2x}TiO₃ (LLTO, 0<x<0.16, □: vacancy), which is a material with a perovskite structure, may be selected.

As the phosphate-based solid electrolyte, Li₁₊ₓAlₓTi₂₋ₓ(PO₄)₃ (x=0˜0.4), which is a material with a NASICON structure, may be selected.

The sulfide-based solid electrolyte may be selected from compound groups basically containing a chalcogenide element and lithium, that is, a material such as Li₁₀SnP₂S₁₂ and Li₄₋ₓSn₁₋ₓAsₓS₄ (x=0 to 100) in a Li_{10±1}MP₂X₁₂ (M═Ge, Si, Sn, Al or P, and X═S or Se) group, a material such as Li_{3.25}Ge_{0.25}P_{0.75}S₄ and Li₁₀GeP₂S₁₂ in a thio-lithium superionic conductor (thio-LISICON) group, a material such as Li₆PS₅Cl in a Li-argyrodite Li₆PS₅X (X═Cl, Br or I) group, a material such as a composition selected from a Li₂S.P₂S₅ (xLi₂S.(100-x)P₂S₅, x=0˜100) group with a glass-ceramic structure, and a material such as Li₂.P₂S₅, Li₂S.SiS₂.Li₃N, Li₂S.P₂S₅.LiI, Li₂S.SiS₂.LiₓMO_{y}, Li₂S.GeS₂, or Li₂S.B₂S₃.LiI in a group having a glass structure.

The polymer-based solid electrolyte may include one or two or more selected from among polyethylene oxide (PEO), polyvinyl chloride (PVC), polyacrylonitrile (PAN), poly(methyl methacrylate) (PMMA), polyvinylidene fluoride (PVDF), a polyvinylidene fluoride-hexafluoropropylene (P(VDF-HFP)) copolymer, and mixtures thereof. In this case, the lithium salt included in the polymer-based solid electrolyte may include one selected from among LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, LiFSI, LiTFSI, LiBETI, LiBPB, LiCTFSI, LiTDI, LiPDI, and a combination thereof.

Next, an electrode made of lithium, sodium, magnesium, potassium, or the like may be used as a counter electrode of the electrolyte-free electrode 13 of the all-solid-state battery 10. The counter electrode, i.e., the first electrode 11, may be formed in a foil or powder type.

Finally, the all-solid-state battery 10 including the counter electrode 11, the solid electrolyte layer 12, and the electrolyte-free electrode 13 is pressed at a pressure of 50 MPa to 100 MPa to form a fully bonded electrode/electrolyte interface. When such a final pressing process is applied, a cause of unstable contact between electrode/electrolyte, which results in high interfacial resistance and adversely affects battery characteristics, may be eliminated.

As shown in FIG. 1B, the electrolyte-free electrode 13 of the present exemplary embodiment may include the granular unit electrodes 130. Each of the unit electrodes 130 may be formed of graphite or the like. When the granular unit electrodes 130 are used, a filling amount of the electrolyte-free electrode 13 may be reduced, and accordingly, manufacturing costs of the battery may be reduced.

The thickness t1 of the electrolyte-free electrode 13 in the stacking direction is definitely smaller than the thickness t2 (see FIG. 4B) of the electrolyte-free electrode 23 of a comparative example to be described below.

Further, a pore density of the electrolyte-free electrode 13 is preferably less than or equal to about 15%, and more preferably less than or equal to 5% on the basis of an electrode bulk density. That is, a pore density of an electrode may be calculated on the basis of an electrode volume occupied by an electrode composition within a total volume with respect to the total volume roughly defined by an outer surface of the electrode. Such a pore density of the electrode may correspond to a pore density decreasing by about 25% to about 75% when compared to about 20%, which is a pore density of a liquid electrolyte-based electrode.

In addition, as shown in FIG. 1C, which is an enlarged view of a specific portion Al of FIG. 1B, in the all-solid-state battery 10, lithium ions (Li⁺) moving from the counter electrode to the electrolyte-free electrode 13 through the solid electrolyte layer 12 may be effectively diffused through a first ion diffusion path 131 and a second ion diffusion path 131a in the electrolyte-free electrode 13. This is because, when the binder is a sodium-based binder (e.g., sodium carboxymethyl cellulose (Na-CMC)), additional concerted exchange movement of the lithium ions moving from the counter electrode to the electrolyte-free electrode 13 and interstitial lithium ions in the electrolyte-free electrode 13 occurs to promote the diffusion of the lithium ions in the second ion diffusion path 131a. The concerted exchange movement may be referred to as a cooperative exchange movement.

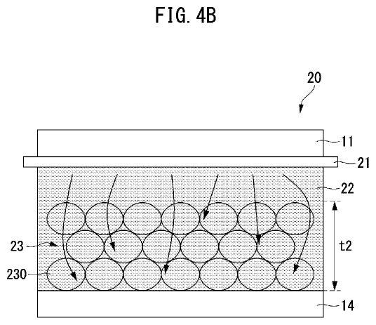

Such a mechanism of promoting the diffusion of lithium ions may be confirmed by examining a transport behavior of lithium ions through Ab-initio molecular dynamics (AIMD) simulation performed on the lithium carboxymethyl cellulose (Li-CMC)-based electrolyte-free electrode 13 and an Na-CMC-based electrolyte-free electrode 13a (see FIG. 5B) of a comparative example. According to the examination of the transport behavior of lithium ions, it can be seen that, in the Li-CMC-based electrolyte-free electrode 13, additional concerted exchange movement of the existing lithium ions and interstitial lithium ions occurs to promote a three-dimensional (3D) diffusion path for lithium ions, but, in the Na-CMC-based electrolyte-free electrode, the concerted exchange movement of the existing lithium ions and the interstitial lithium ions hardly occurs.

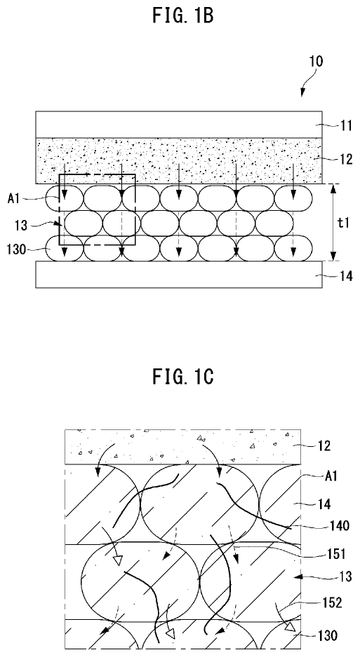

FIG. 2 is a view for describing a synthetic route of a binder for an electrolyte-free electrode that can be employed in the all-solid-state battery of FIG. 1.

FIG. 2 schematically illustrates a synthesis route for conversion of pure Na-CMC to Li-CMC through a two-step cation exchange process based on an acid-base reaction theory. In FIG. 2, hydrogen carboxymethyl cellulose (H-CMC) is obtained by acid-treating Na-CMC using hydrochloric acid (HCl) or p-toluenesulfonic acid (pTsOH). Meanwhile, the exchange reaction of sodium ions (Na⁺) and hydrogen ions (H⁺) hardly occurs when treated with acetic acid (AA), and thus it exhibits a slightly higher acidity (pKa) than that of carboxymethyl cellulose (CMC).

As shown in FIG. 2, since direct conversion from Na-CMC to Li-CMC is not feasible due to the similarity between Na- and Li-coordinated carboxylate structures, the acid form (H-CMC) of CMC is first prepared from Na-CMC. In general, strong acids may be suitable to promote Na⁺/H⁺ exchange but may be accompanied by potential hydrolysis degradation of the CMC binder. For this reason, in the present exemplary embodiment, an optimized acid treatment may be performed using three different acids, that is, hydrochloric acid, p-toluenesulfonic acid, and acetic acid (AA) in descending order of acidity to investigate the effect of acidity of the aqueous reaction medium on the generated H-CMC and Na⁺/H⁺ exchange.

Thereafter, when the H-CMC is simply treated in a lithium hydroxide monohydrate (LiOH.H₂O) solution, high-purity Li-CMC is generated through H⁺/Li⁺ exchange.

Meanwhile, Fourier-transform infrared spectroscopy (FT-IR) analysis may be performed to confirm a unique functional structure of a CMC sample related to, in particular, cation-coordinated carboxylates.

According to an FT-IR analysis result, characteristic peaks corresponding to the ether series (—O— at about 1058 cm⁻¹), hydroxyl groups (—OH stretching at 3600 to 3000 cm⁻¹) and methyl groups (C—H stretching at 2922 cm⁻¹) are all observed. This indicates that an original cellulose structure was maintained well during the two-step cation exchange process. Eventually, a new transmittance peak related to —COOH groups did not appear at 1740 cm⁻¹ for both Na-CMC treated with HCl and pTsOH, and signals (peaks at 1328, 1424, and 1602 cm⁻¹) related to Na-coordinated carboxylates of pure Na-CMC still appeared in Na-CMC treated with acetic acid (AA).

AA, known as a weak acid, exhibited a slightly higher acidity (pKa) than CMC as compared to hydrochloric acid (HCl) or p-toluenesulfonic acid (pTsOH), indicating that Na⁺/H⁺ exchange was hardly made. In contrast, the treatment with HCl or pTsOH was confirmed to lower the solubility of an H-CMC solution, this is due to the increase in the hydrophobicity of an alkyl chain of H-CMC as compared to Na-CMC. In contrast, after H⁺/Li⁺ exchange, in Li-CMC obtained from the HCl— and pTsOH treated H-CMC, the —COOH group peak disappeared, and at the same time, an FT-IR spectrum similar to that of the original Na-CMC appeared.

In addition, X-ray photoelectron spectroscopy (XPS) measurement may be performed to accurately characterize and compare chemical structures of the CMC sample. In an XPS measurement result, it can be seen that, in the HCl and pTsOH-treated H-CMC, peaks for Na 1 s or Na 2 s did not appear, but peaks related to Na (Na 1 s at about 1071 eV and Na 2 s at about 63 eV) were clearly observed in pure Na-CMC and AA-treated H-CMC. This is consistent with the above-mentioned FT-IR analysis result.

In addition, it is possible to examine the effect of acidity on a structure of a polymer chain and CMC due to the potential decomposition of the CMC upon acid treatment. In consideration of the fact that viscosity is an excellent practical measurement for predicting a molecular weight of a polymer, a pure Na-CMC solution (1 wt % in water) and a differently treated Li-CMC solution (1 wt % in water) may be prepared for viscosity measurement. Na-CMC may be prepared by directly reacting with a LiOH.H₂O solution to compare the viscosity of the mixed CMC in a partial exchange reaction of Na⁺/Li⁺.

As a result of the examination of the effect of acidity, there was no noticeable difference in viscosity between Na-CMC and pTsOH-treated Li-CMC, this means that the original structure of the polymer chain did not undergo physical decomposition during pTsOH treatment.

Meanwhile, the viscosity of HCl-treated Li-CMC was about 2 to 3 times lower than that of Na-CMC and pTsOH-treated Li-CMC. Such a result indicates that the acidity of HCl is strong enough to promote severe hydrolytic cleavage of glycosidic bonds in a CMC backbone.

Further, in addition to maintaining structural integrity, pTsOH treatment exhibited higher reaction efficiency and thus shortened a reaction time for Na⁺/H⁺ exchange by about 2 hours as compared to about 4 hours for HCl. That is, such a pTsOH treatment result shows that pTsOH is a more effective and suitable acid for converting Na-CMC into H-CMC as compared to HCl.

As described above, in the present exemplary embodiment, pTsOH may be used for glycosidic bond cleavage in a process of converting Na-CMC to H-CMC in a strong acidic environment. Meanwhile, in the case of HCl, since protons are more likely to attack glycosidic bonds of a cellulose backbone, significant consumption of protons may accompany to interfere with Na⁺/H⁺ exchange.

In addition, the viscosity of the mixed CMC was similar to the viscosity of Na-CMC and pTsOH-treated Li-CMC, which shows that a lithiation step did not cause physical decomposition of the CMC.

Further, in order to compare the bonding performance of the manufactured Li-CMC binder, an electrode (graphite:CMC″SBR=97:2:1, wt %) composed of graphite, Li-CMC, and styrene butadiene rubber (SBR) may be fabricated and then subjected to a 90° peel test, and the test may be performed together with a graphite electrode based on PVDF (2 and 4 wt %) for comparison. Here, an electrode thickness of each sample may be about 40 μm.

As a result of the comparison, average peel strengths of the electrodes having Na-CMC and pTsOH-treated Li-CMC are 4.48 and 4.38 gf mm⁻¹, respectively, whereas HCl-treated Li-CMC showed a significantly lower value (1.32 gf mm⁻¹) in viscosity results. The above physical evaluation shows that the cation exchange reaction using pTsOH is an efficient method to fabricate Li-CMC that maintains excellent adhesion.

Based on the above-described examination result, an electrolyte-free electrode-based all-solid-state battery (see FIGS. 1A and 1B) was fabricated, and the effects of a Li-CMC binder on lithium ion (Li⁺) transport and electrode performance were examined and compared. Here, the electrolyte-free electrode is a graphite electrode using Li-CMC obtained from pTsOH-treated Na-CMC, and an electrode composition thereof may be graphite/CMC/SBR=97:2:1 (wt %) and may be referred to simply as Li-CMC.

As described above, since the electrolyte-free electrode does not include a solid electrolyte as well as a liquid electrolyte, the compatibility problem between electrode components, which is commonly observed in the process of manufacturing an ASSB electrode, is no longer critical. In such a simplified electrode configuration, Li⁺ transport starting at an interface between the solid electrolyte layer and the electrode is potentially impeded by the inert binder and thus occurs only by inter-particle diffusion, which ultimately leads to deterioration of interfacial conduction.

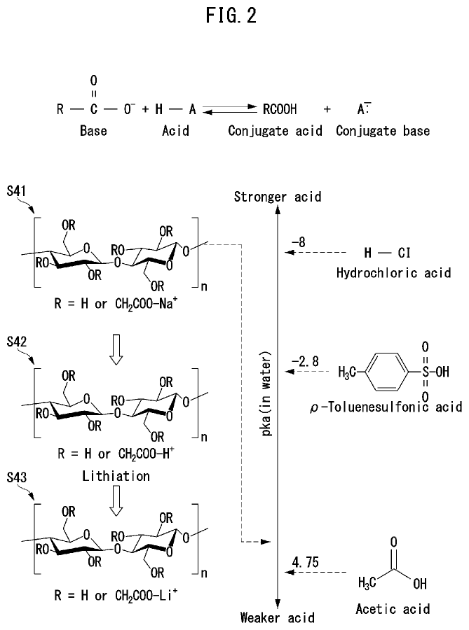

FIG. 3 is a schematic cross-sectional view of an all-solid-state battery according to exemplary embodiments of the present disclosure.

Referring to FIG. 3, the all-solid-state battery (ASSB) includes a counter electrode 11, a solid electrolyte layer 12a, and an electrolyte-free electrode 13. The counter electrode 11, the solid electrolyte layer 12a, and the electrolyte-free electrode 13 may have a stacked structure, and the counter electrode 11 may be formed of lithium metal. In addition, as a material of the solid electrolyte layer 12a, Li₆PS₅Cl (LPSCl), which is an argyrodite-type sulfide solid electrolyte, may be used.

In order to prevent the solid electrolyte from being accidentally included in the electrolyte-free electrode 13 during an operation of compressing the counter electrode 11, the solid electrolyte layer 12a, and the electrolyte-free electrode 13, the solid electrolyte layer 12a and the electrolyte-free electrode 13 may be closely disposed by being separately compressed and stacked before combining the solid electrolyte layer 12a and the electrolyte-free electrode 13 into a single body.

The structure with a clear contrast between the electrolyte-free electrode 13 and the LPSCl layer in the all-solid-state battery may be confirmed through a scanning electron microscope (SEM) image and an energy-dispersive x-ray spectroscopy (EDS)-mapping image corresponding thereto.

As a result of checking the cross-sectional SEM and EDS mapping images of the all-solid-state battery, a clear contrast between the solid electrolyte layer 12a and the counter electrode 11 may be observed. This indicates that a smooth interface is formed between the solid electrolyte layer 12a and the counter electrode 11 during the manufacture of the battery.

FIG. 4A is a conceptual view of a lithium-ion battery using an electrode impregnated in a liquid electrolyte of a comparative example, and FIG. 4B is a front view of the lithium-ion battery of FIG. 4A.

Referring to FIGS. 4A and 4B, in a lithium-ion battery (LIB) 20 of the comparative example, a liquid electrolyte (LE) 22 easily penetrates into an electrode 23 through an internal pore microstructure to form a continuous ion-conducting network. The lithium-ion battery 20 has a configuration including the liquid electrolyte 22, which is disposed between a separator 21 connected to a counter electrode 11 and a current collector 14, and the electrode 23 impregnated in the liquid electrolyte. The electrode 23 may include a graphite electrode as a unit electrode 230.

In the lithium-ion battery 20 of the comparative example described above, the role of an ion-conducting binder in the LE-impregnated electrode configuration may be limited or difficult to recognize. That is, in the lithium-ion battery based on the liquid electrolyte 22, a large portion of lithium ions from the counter electrode 11 directly move to the LE-impregnated electrode 23 through the liquid electrolyte 22, and thus the ion-conducting binder in the electrode configuration may not be evaluated properly. In particular, under experimental conditions of LE-based LIBs, a lithium conducting binder only exhibits a slightly increased capacity relative to an inert binder even at a high current rate and/or a high loading level.

As described above, in order to accurately evaluate the contribution of an ion-conducting binder used in an electrode of a lithium-ion battery, a new electrode structure that avoids potential intervention of electrolyte components during operation is required. Accordingly, in the present exemplary embodiment, an all-solid-state battery (hereinafter referred to as a first all-solid-state battery) using a Li-CMC-based electrolyte-free electrode and an all-solid-state battery (hereinafter referred to as a second all-solid-state battery) using a Na-CMC-based electrolyte-free electrode are manufactured, and a performance evaluation thereof may be conducted to evaluate an ion conductivity of Li-CMC.

FIG. 5A is a view for describing the flow of ions in the electrode during a charging process of the all-solid-state battery of the present exemplary embodiment, and FIG. 5B a view illustrating the flow of ions in the electrode during the charging process of the all-solid-state battery of a comparative example.

As shown in FIG. 5A, a first all-solid-state battery 10a of the present exemplary embodiment includes a solid electrolyte layer 12, and a Li-CMC-based electrolyte-free electrode 13 (hereinafter, briefly referred to as a first electrolyte-free electrode). In the first all-solid-state battery 10a, a counter electrode may be disposed on an upper side surface of the solid electrolyte layer 12, and a current collector 14 may be provided on a lower side surface of the first electrolyte-free electrode 13.

As shown in FIG. 5B, a second all-solid-state battery 30 of the comparative example includes a solid electrolyte layer 12 and a Na-CMC-based electrolyte-free electrode 13a (hereinafter, briefly referred to as a second electrolyte-free electrode). In the second all-solid-state battery 30, a counter electrode may be disposed on an upper side surface of the solid electrolyte layer 12, and a current collector 14 may be provided on a lower side surface of the second electrolyte-free electrode 13a.

As described above, in order to evaluate the ion conductivity of Li-CMC, the second all-solid-state battery 30 may be manufactured to have substantially the same structure and configuration as the first all-solid-state battery 10a except that Na-CMC is used.

When a manufacturing process of the first all-solid-state battery 10a is described in more detail, Li-CMC, which is an ion-conducting binder of the present exemplary embodiment, may be synthesized from Na-CMC, which is a non-ion-conducting binder. That is, a Na-CMC binder is put in a hydrochloric acid/ethanol (15:85, volume ratio) mixed solution and reacted with the mixed solution to synthesize carboxylic acid (H-CMC), and then reacted again with a lithium hydroxide (LiOH) solution to synthesize Li-CMC.

In order to manufacture an electrode from which an electrolyte component is completely excluded, that is, the electrolyte-free electrode 13, a slurry process may be performed using natural graphite as an electrode active material, a mixed binder of Li-CMC and SBR as a binder, and deionized water as a solvent. The composition of the electrolyte-free electrode 13 may have a weight ratio of natural graphite:Li-CMC:SBR of 97:2:1. In order to well mix the electrode slurry, the electrode slurry may be mixed in a range of 1000 rpm to 2000 rpm through a planetary mixer or the like.

More specifically, in a preparation sequence of the electrode slurry, first, natural graphite and a binder solution in which a 1.5 wt % of a Li-CMC binder is contained in deionized water may be mixed at 1500 rpm for 10 minutes. Next, an appropriate amount of an SBR solution of 40 wt % is additionally put in the deionized water, and the mixture may be mixed again for 10 minutes.

The prepared electrode slurry may be coated on a nickel foil by a doctor blade method. A coating thickness may be adjusted by adjusting a blade interval of the doctor blade. An electrode density in the electrode slurry may be controlled to 2 to 20 mg/cm². After the coating, initial drying is performed at 100° C., and then vacuum drying may be performed at 90° C. for 10 to 15 hours. In addition, an electrode density of the electrolyte-free electrode may be increased through a pressing process.

According to the above-described configuration, a half cell composed of the electrolyte-free electrode 13 based on graphite and Li-CMC, the solid electrolyte layer 12, and the counter electrode may be fabricated. The solid electrolyte layer 12 between both electrodes may use a Li₆PS₅Cl (LPSCI) in the form of a layer. A lithium foil having a thickness of 300 μm may be used as the counter electrode (see FIGS. 1A and 1B).

In addition, in order to manufacture the first all-solid-state battery 10a based on the electrolyte-free electrode 13, first, an LPSCI layer to be formed as the solid electrolyte layer 12 may be pre-pressed to a thickness of 1000 μm through a pressure of 50 MPa. Next, the Li-CMC binder-based electrolyte-free electrode 13 may be brought into contact with one side surface of the LPSCI layer, and then an interface therebetween may be formed at a pressure of 350 MPa. Thereafter, a lithium foil may be brought into contact with an opposite side surface of the LPSCI layer, and then a pressure of 50 MPa may be applied to manufacture an all-solid-state secondary battery.

Meanwhile, the manufacturing process of the first all-solid-state battery 10a of the present exemplary embodiment is applied to the second all-solid-state battery 30 of the comparative example in the same manner except that an electrolyte-free electrode-based all-solid-state battery is manufactured using Na-CMC, which is a non-ion-conducting binder.

Here, a material of the non-ion-conducting binder may include one selected from among polytetrafluoroethylene, polyvinylidene fluoride, polyvinylidene fluoride-hexafluoropropylene, poly(ethylene oxide), polyacrylonitrile, polyacrylic acid, styrene-butadiene, nitrile-butadiene rubber, butadiene rubber, a cellulose derivative, and a combination thereof in addition to the above-described Na-CMC.

In addition, the cellulose derivative may include one selected from among ethyl cellulose, hydroxypropyl cellulose, cellulose, methyl cellulose, ethyl cellulose, butyl cellulose, hydroxypropyl cellulose, cellulose nitrate, cellulose acetate, cellulose acetate propionate, cellulose acetate butyrate, carboxymethyl cellulose, xanthan gum, pectin, guar gum, dextran, and a mixed composition thereof.

A lithiation phenomenon in the electrolyte-free electrode during a charging period of the above-described first all-solid-state battery 10a and second all-solid-state battery 30 is visually exemplified as shown in FIGS. 5A and 5B. Each of the charging processes is exemplified and illustrated in a direction of an arrow in each of FIGS. 5A and 5B. That is, among the unit electrodes provided in each of the first electrolyte-free electrode 13 and the second electrolyte-free electrode 13a, unit electrodes 131 (hereinafter, referred to as first unit electrodes) in which lithium ions are moved or diffused are hatched and displayed, and thus exemplified to contrast with unit electrodes 132 (hereinafter referred to as second unit electrodes) in which the lithium ions have not yet been moved or diffused.

An electrochemical test of the present exemplary embodiment was performed at 60° C., where Li⁺ diffusion was promoted with slow kinetics. That is, in order for full capacity utilization of the electrolyte-free electrode, a constant-current (CC)-constant voltage (CV) charging mode was employed. The CC-CV charging mode may be referred to as a CC-CV lithiation mode.

As described above, the ion-conducting binder evaluation system for a secondary battery of the present exemplary embodiment may evaluate the performance of an ion-conducting binder, i.e., a relative contribution to lithium ions in an electrode, by configuring an electrolyte-free electrode using electrode active material particles with high electron conductivity based on a nonionic binder or an ionic binder, using the electrolyte-free electrode as an electrolyte-free electrode of an all-solid-state battery, and performing electrochemical performance tests on the all-solid-state battery.

The relative performance evaluation of the ion-conducting binder through the electrochemical and battery characteristics evaluation of the all-solid-state battery may include evaluations of the time required for fully charging, capacity according to a change in charge/discharge rate, internal resistance of a battery, capacity according to an active material loading level, capacity according to a driving temperature, and the like.

The performance evaluation of the ion-conducting binder in the electrode on the basis of the evaluation of the electrolyte-free electrode-based all-solid-state battery will be described in more detail as follows.

First, the time required for fully charging may be evaluated through CC-CV mode charging and CC mode discharging. The CC-CV mode charging may correspond to lithiation, that is, the performance of intercalating lithium ions into the electrode, and the CC mode discharging may correspond to delithiation, that is, the performance of deintercalating the lithium ions from the electrode.

The electrolyte-free electrode of the present exemplary embodiment may be charged/discharged using the mechanism of ion diffusion through contact between active material particles and thus may be tested at 60° C. to facilitate the movement of ions. The maximum lithium intercalation behavior may be derived by setting a charge/discharge voltage during the test to a range of 0.01 V to 2 V and a cut-off current during the CC-CV mode charging to 1/5 to 1/10. That is, when charging in the CC mode, a ion distribution in the electrode may be non-uniformly formed, and an electrode surface voltage may quickly reach a cut-off voltage and the charging may be terminated, so that the maximum charge amount may not be guaranteed. On the other hand, when charging in the CC-CV mode, the charging proceeds as the current decreases until reaching the cut-off current after reaching the cut-off voltage, so that a more uniform ion distribution in the electrode may be formed, and accordingly, the maximum charge amount may be induced. The time required for maximum charging of the electrode, which is based on the non-ion-conducting binder and the ion-conducting binder, at a predetermined charge/discharge rate may be compared through the CC-CV mode charging method.

Next, the capacity according to the change in charge/discharge rate may be evaluated by comparing the maximum charge amount of the electrode based on the non-ion-conducting binder and the ion-conducting binder while adjusting the charge/discharge rate to 0.05 to 10.0 C when charging in the CC-CV mode. Here, 1 coulomb (C) refers to a rate to reach the maximum charge amount in one hour.

Next, the internal resistance of the battery may be evaluated by constituting an all-solid-state battery composed of a Li/solid electrolyte layer/electrode (electrolyte-free electrode) using a non-ion-conducting binder or an ion-conducting binder and applying an alternating current (AC) impedance in a range of 10⁻¹ Hz to 10⁵ Hz to the all-solid-state battery using a frequency response analyzer.

Next, the capacity according to the active material loading level may be evaluated by measuring and comparing the maximum charge amount and capacity realization rate of each of the electrolyte-free electrodes based on the non-ion-conducting binder and the ion-conducting binder while adjusting the active material loading level of the electrolyte-free electrode to 2 to 20 mg/cm².

Next, the capacity according to the driving temperature may be evaluated by measuring and comparing the maximum charge amount of each of the electrolyte-free electrodes based on the non-ion-conducting binder and the ion-conducting binder while adjusting charge/discharge driving temperature.

When each of the range of the charge/discharge voltage, the range of the cut-off current, the range of the charge/discharge rate, the range of frequencies at which the AC impedance is applied, and the range of the active material loading level in the above-described measurement process is less than a lower limit value thereof, it is difficult to distinguish the difference due to insignificant measurement information, and when each of these ranges is greater than an upper limit value thereof, since the measurement information may be unnecessarily excessively larger than a value range for appropriate evaluation, it is preferable to perform the test by limiting the test conditions to the above-described ranges.

Meanwhile, it was found that even a small amount of binder, for example, a binder with a content of 3 wt % or less, can induce significant internal resistance in the ASSB electrode, and thus charge/discharge characteristics of an increased electrolyte-free electrode were examined. In addition, as a result of the experiment according to the binder capacity, the two electrodes both showed similar levels of capacity at 0.1 C (1.85 mA/cm⁻²) and 60° C., but when the binder content was increased, the capacity was lower than the theoretical value. As described above, in order to emphasize the conducting role of the Li-CMC binder, the ratio of the binder is preferably 94:4.5:1.5 wt % with respect to graphite:CMC:SBR.

Further, the Li-CMC-based electrode (hereinafter, also briefly referred to as a Li-CMC electrode) showed reduced overpotential (about 0.19 V) and charging time (about 13.3 h) as compared to those (about 0.27 V and about 17.6 h) of the Na-CMC-based electrode (hereinafter, also briefly referred to as Na-CMC electrode). According to such a result, the performance of the Li-CMC electrode significantly exceeded the performance of the electrode of the comparative example, which means that severe interruption of interfacial conduction especially at a high charge/discharge rate has been mitigated by using the conducting binder.

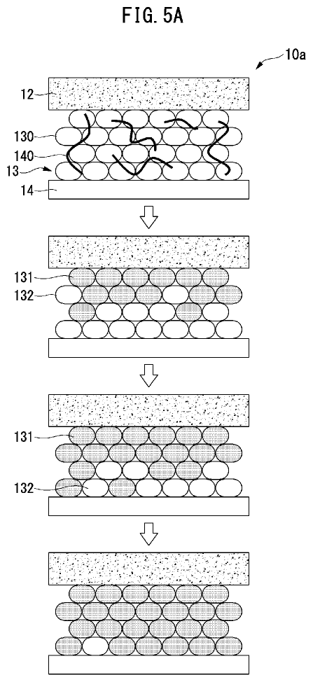

FIG. 6A is a time versus voltage graph illustrating charging and discharging of the ion-conducting binder-based electrode of the present exemplary embodiment. FIG. 6B is a time versus voltage graph illustrating charging and discharging of the non-ion-conducting binder-based electrode of the comparative example.

In the present exemplary embodiment, the result of testing voltage versus capacity of the electrolyte-free electrodes, which are respectively using Na-CMC and Li-CMC, in the initial three cycles when the voltage of each battery is measured at 0.1 C (about 0.19 mA/cm⁻²) and 60° C., will be described.

As a result of the test, it was confirmed that the Li-CMC electrode exhibited a slightly higher delithiation capacity (about 1.87 mAh/cm⁻² corresponding to 353.49 mAh g⁻¹) as compared to that (about 1.76 mAh cm⁻² corresponding to 332.70 mAh g⁻¹) of the Na-CMC electrode despite cycling at 0.1 C. Further, it was found that the Na-CMC electrode reached the cut-off voltage faster than the Li-CMC electrode, and this is due to the increased overpotential (about 0.23 V) of Na-CMC as compared to Li-CMC (about 0.16V). In consideration of the fact that a current is gradually reduced until the current reaches a preset current level in the CV charging mode, the Na-CMC electrode is preferably charged for a long time for full capacity utilization. Thus, the time required for the CC-CV charging is compared through voltage-time profiles of the two electrodes. This is shown in FIGS. 6A and 6B. The test was performed in a room temperature (RT) atmosphere, and the theoretical capacity of the tested battery was 2.9 mAh cm⁻².

As shown in FIG. 6A of the present exemplary embodiment and FIG. 6B of the comparative example, a significant difference in charging time was observed around 10.8 hours for the Li-CMC-based electrode and around 13.1 hours for the Na-CMC-based electrode mainly due to the CV charging mode.

The above results are in great contrast to the case of the liquid electrolyte-based lithium secondary battery in which two CMC binders show the same profile in both voltage-versus-capacity and voltage-versus-time plots. The mismatch of the CC-CV charging between the two electrolyte-free electrodes may be analyzed by quantifying the charging time and capacity corresponding to the CV mode. That is, a ratio obtained by quantifying a charging time according to the CC-CV charging mode in 1^{st} and 2^{nd} cycles and a relative capacity of the CC and CV charging modes in the 2nd cycle may be confirmed. In this case, during the CV charging, a charging time (about 1.53 h) of the Li-CMC electrode was three times shorter than that of the electrode (about 5.23 h) of the comparative example in the 2^{nd} cycle. As a result, it can be seen that capacity utilization in a CV charging operation is much lower in the Li-CMC electrode than in the Na-CMC electrode, unlike a CC charging operation.

Table 1 summarizes the charging time and capacity of each of the electrolyte-free electrodes using the Na-CMC and Li-CMC in the 1^{st} and 2^{nd} cycles in the CC-CV charging mode.

TABLE 1

| | 1^{st} cycle (formation) | | | | | | 2^{nd} cycle | | | | | |
|---|---|---|---|---|---|---|---|---|---|---|---|---|
| | Charging time (h) | | | Capacity (mAh cm⁻²) | | | Charging time (h) | | | Capacity (mAh cm⁻²) | | |
| | CC | CV | | CC | CV | | CC | CV | | CC | CV | |
| Electrode | mode | mode | Total | mode | mode | Total | mode | mode | Total | mode | mode | Total |
| Na-CMC | 9.95 | 5.21 | 15.16 | 1.85 | 0.4 | 2.22 | 7.77 | 5.23 | 13 | 1.44 | 0.4 | 1.84 |
| Li-CMC | 10.6 | 1.93 | 12.55 | 1.81 | 0.27 | 2.08 | 9.37 | 1.53 | 10.9 | 1.73 | 0.16 | 1.89 |

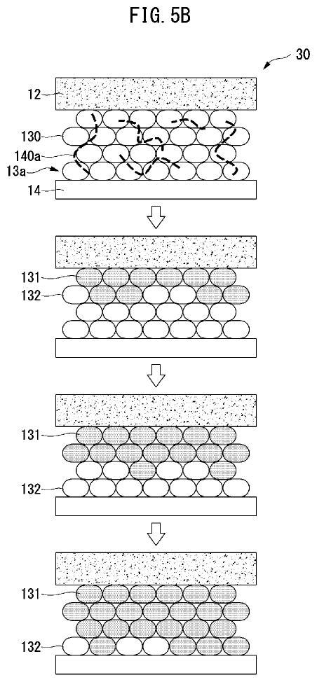

FIG. 7 is a graph illustrating changes in areal capacity according to a charging time in the all-solid-state batteries respectively using the ion-conducting binder-based electrode of the present exemplary embodiment and the non-ion-conducting binder-based electrode of the comparative example.

Referring to FIG. 7, in order to further understand the effect of the binder on the charging time, the results obtained by examining the capacity-versus-time plots for the two electrolyte-free electrodes of the first all-solid-state battery and the second all-solid-state battery can be observed in two separate regions (region I and region II).

In a first region (region I), an aerial capacity of each of the two electrodes in the CC charging mode was linearly increased according to a charging time. On the other hand, in a second region (region II), a phenomenon appeared in which a charging time of the Na-CMC electrode, which encounters the CV mode earlier than the Li-CMC electrode, was increased.

Since the electrolyte-free electrode can accept pure Li⁺ ions from the LPSCI layer, a concentration gradient of the Li⁺ ions is inevitably generated in the charging/discharging electrode. In this situation, inert Na-CMC may interfere with inter-particle diffusion, which reflects the increased overpotential of the battery, to cause serious accumulation of Li⁺ ions near a surface of the electrode.

For this reason, a surface potential of the Na-CMC-based electrolyte-free electrode decreases more rapidly to the cut-off voltage, and then, the CV mode is continued after the CC mode is stopped at a first switching point, so that the charging time is extended to reach maximum capacity utilization, which corresponds to the case of a high loading battery or a battery operated at a high charge/discharge rate or a low temperature.

Meanwhile, the Li-CMC electrode may mitigate the interruption of interfacial conduction and reduce the internal resistance due to ion conductivity, i.e., lithium ion (Li⁺) conductivity. That is, a second switching point of the Li-CMC-based electrolyte-free electrode is switched from the CC mode to the CV mode at a relatively larger areal capacity or a later charging time to shorten the charging time until fully charged.

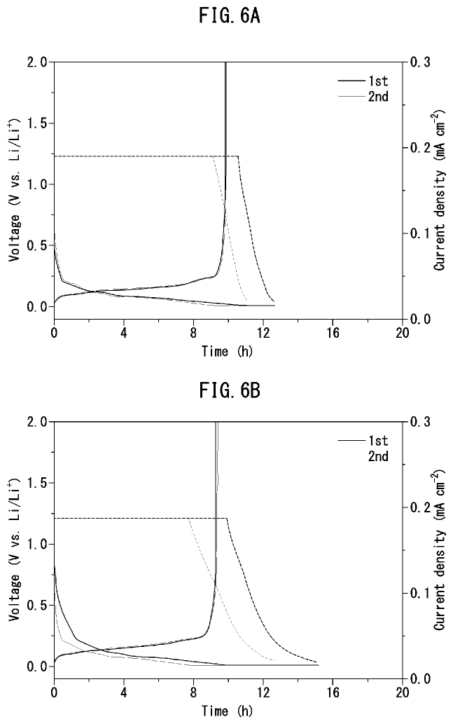

FIG. 8 is a graph comparing and illustrating changes in areal capacity according a charge/discharge rate in the all-solid-state batteries respectively using the ion-conducting binder-based electrode of the present exemplary embodiment and the non-ion-conducting binder-based electrode of the comparative example.

Referring to FIG. 8, it is possible to confirm an electrochemical test result for the areal capacity of the electrolyte-free electrode, which was performed at various charge/discharge rates and in a temperature atmosphere of 60° C. That is, as the charge/discharge rate increases, the ion-conducting binder-based electrode showed a higher capacity than the non-ion-conducting binder-based electrode. In the test, the theoretical capacity was about 1.9 mAh cm⁻², and the charge/discharge rate was varied in a range of 0.1 C to 1 C. Here, the charge rate and the discharge rate are the same.

According to the test result, the Li-CMC electrode showed excellent rate performance and stable capacity retention as compared to the Na-CMC electrode of the comparative example. This confirms that the first electrolyte-free electrode corresponding to the Li-CMC electrode may be an optimum electrode configuration that fully benefits from the Li⁺-conducting binder

In particular, the difference in capacity, which was insignificant at 0.1 C, became larger as the charge/discharge rate increased to 1 C. This means that it is very important to impart Li⁺ conducting capability to the binder to enable excellent interfacial conduction. For example, it shows that it is more important in a severe cycling condition, such as a high charge/discharge rate (C-rate).

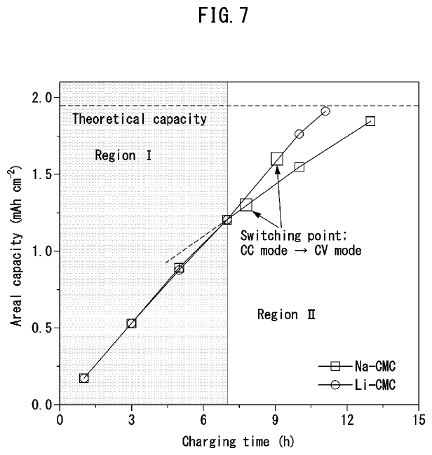

FIG. 9 is a graph comparing and illustrating internal resistances of the all-solid-state batteries respectively using the ion-conducting binder-based electrode of the present exemplary embodiment and the non-ion-conducting binder-based electrode of the comparative example.

FIG. 9 illustrates an electrochemical impedance spectroscopy (EIS) plot of the electrolyte-free electrodes. That is, in the EIS plot, a total interface resistance, which consists of a solid-electrolyte interphase (SEI) resistance and a charge transfer resistance, in a high-frequency region or an intermediate-frequency region is shown. The EIS plot may be built using a predetermined equivalent circuit model.

An internal sheet resistance (217.1 Ω/cm²) of a semicircle section in the Li-CMC electrode is lower than an internal sheet resistance (338.9 Ω/cm²) of the Na-CMC electrode. This indicates that the interfacial conduction is improved using Li-CMC.

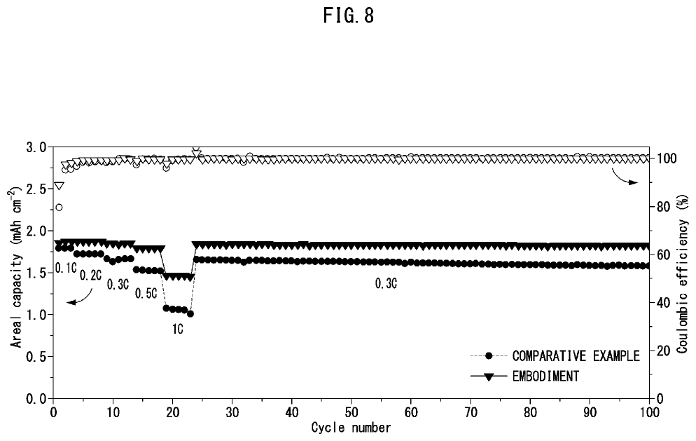

FIG. 10 is a graph illustrating areal capacities, which are measured at different loading levels of the electrode at a charge/discharge rate of 0.1 C and in a temperature atmosphere of 60° C. for the all-solid-state batteries respectively using the Li-CMC binder-based electrode of the present exemplary embodiment and the Na-CMC binder-based electrode of the comparative example, and capacity utilizations according thereto.

Referring to FIG. 10, the areal capacities of the electrolyte-free electrodes having various loading levels may be confirmed.

It should be noted that, in the present exemplary embodiment using Li-CMC, diffusion-limiting capacity is generated due to the increased diffusion path, which results in an increased loading level and thus full capacity utilization is hardly achievable. In this regard, a beneficial contribution of the conducting binder to implementing a high-energy-density electrode may be confirmed.

That is, it can be seen that even when electrodes (graphite/CMC/SBR=97:2:1, wt %) with loading levels of 3.37, 5.29, and 9.28 mg cm⁻² (corresponding to areal capacities of 1.21, 1.90, and 3.33 mAh cm⁻²) are charged and discharged at 0.1 C and 60° C., the capacity utilizations (99.8%, 93%, and 92.1%) of the Li-CMC electrode of the present exemplary embodiment are higher than those (99.1%, 89.5%, and 86.4%) of the Na-CMC electrode of the comparative example.

Meanwhile, expected characteristics of the electrolyte-free electrode may be compared with those of a composite electrode in terms of energy density. A composite electrode (graphite/LPSCl/super-P=75:24:1, wt %) having a loading level of 6.84 mg cm⁻² and designed to have the same capacity level as the electrolyte-free electrode may be manufactured by a dry-mixing process and tested. In this case, the composite electrode having a strong ion-conducting network provided with a solid electrolyte may exhibit a higher areal capacity than the electrolyte-free electrode. However, a relatively low energy density may be exhibited as a thickness of the composite electrode increases as compared to the electrolyte-free electrode due to the addition of the solid electrolyte. The Li-CMC electrode with a thickness of 30 μm may exhibit volumetric capacities of 620.1 and 490.2 mAhcm⁻³, which are respectively higher than volumetric capacities (513.5 and 478.3 mAhcm⁻³) of the composite electrode with a thickness of 36 μm, respectively at 0.1 C (60° C.) and 1.0 C (60° C.).

A gravimetric capacity based on an electrode weight showed a similar trend. Table 2 below illustrates specifications of the electrolyte-free electrode employing Na-CMC or Li-CMC and the composite electrode.

TABLE 2

| | | | | | | | | Volumetric | | | | | |
|---|---|---|---|---|---|---|---|---|---|---|---|---|---|
| | | | Active | | | | | capacity | | | Gravimetric | | |
| | | Loading | loading | | Areal | | | (mAh cm⁻³ | | | capacity | | |
| | Composition | level | level | | capacity | | | electrode)^{c)} | | | (mAh g⁻¹ | | |
| | (weight | (mg | (mg | Thickness | (mAh cm⁻²) | | | C-rate^{e)} | | | electrode)^{d)} | | |
| Electrode | ratio)^{a)} | cm⁻²) | cm⁻²) | (μm)^{b)} | 0.1 | 0.5 | 1 | 0.1 | 0.5 | 1 | 0.1 | 0.5 | 1 |
| Na- | 97:3:0:0 | 5.29 | 5.13 | 30 | 1.76 | 1.52 | 1.07 | 586.6 | 506.6 | 356.6 | 332.4 | 287.1 | 202.1 |
| CMC | | | | | | | | | | | | | |
| Li-CMC | 97:3:0:0 | 5.29 | 5.13 | 30 | 1.86 | 1.79 | 1.47 | 620.0 | 596.6 | 490.0 | 351.4 | 338.1 | 277.6 |
| composite | 75:0:24:1 | 6.84 | 5.13 | 36 | 1.90 | 1.88 | 1.77 | 513.5 | 502.7 | 478.3 | 277.5 | 271.6 | 258.5 |

In Table 2,
^{a)}indicates a case of graphite:binder:LPSCI:super-P,
^{b)}indicates a case without including a current collector,
^{c)}indicates a case based on an electrode thickness,
^{d)}indicates a case based on an electrode weight, and
^{e)}indicates a case in which 1C is 1.9 mA cm⁻².

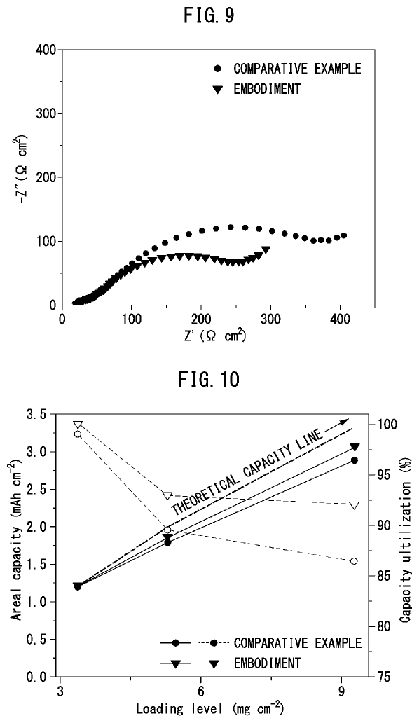

FIG. 11 is a graph comparing and illustrating voltages and sheet resistances of the all-solid-state batteries, which are charged and discharged at room temperature under 0.1 C conditions, respectively using the Li-CMC binder-based electrode of the present exemplary embodiment and the Na-CMC binder-based electrode of the comparative example. In the test, the maximum theoretical capacity was 2.4 mAhcm⁻² and the charging and discharging proceeded in a voltage range of 0.01 V to 2 V.

Referring to FIG. 11, as shown in a profile for a relationship between voltage and areal capacity according to the number of times of charging/discharging during room temperature operation of the electrolyte-free electrode with Na-CMC of the comparative example and the electrolyte-free electrode with Li-CMC of the present exemplary embodiment, it can be seen that the electrode having the conducting binder of the present exemplary embodiment undergoes less slow Li⁺ diffusion kinetics when the electrode is operated at room temperature. That is, a significantly reduced capacity and an extended charging time were observed in the Na-CMC electrode of the comparative example in comparison with the present exemplary embodiment.

In summary, the mechanism of enhancement of overall Li⁺ transport in the electrolyte-free electrode was confirmed using Li-CMC as the ion-conducting binder. That is, it was confirmed that inter-particle Li⁺ diffusion promoted through the increased transport path is feasible with the Li⁺-conducting binder. As a result, it can be seen that the enhanced interfacial conduction of the Li-CMC electrode further mitigates the concentration gradient of Li⁺ ions to shorten the CV charging time and substantially mitigates the internal resistance for full capacity utilization, thereby exhibiting a high capacity. As described above, it can be seen that a battery with Li-CMC has superior performance than a battery with Na-CMC, and thus the possibility of the electrode of the present exemplary embodiment may be confirmed in a practical application field of a battery.

In conclusion, it is possible to evaluate the contribution of an ion-conducting binder to effective capacity utilization by using an electrolyte-free electrode as an ASSB electrode. It was confirmed that the effect of the Li⁺-conducting binder on interfacial conduction may be optimally realized in the electrode from which an electrolyte component is completely excluded. Here, a Li-CMC binder, which is a type of Li⁺-conducting binder, was prepared through a two-step cation exchange reaction by employing an optimized acid treatment to avoid potential physical degradation of the CMC binder, and an electrolyte-free electrode with the Li-CMC binder stably exhibited larger areal and volumetric capacities at 60° C. and relatively high charge/discharge rate (1.91 mAcm⁻²) as compared to the areal and volumetric capacities of Na-CMC binder while achieving the simplicity of electrode manufacture and high bonding strength.

In particular, as a result of systematically monitoring lithiation dynamics in the electrolyte-free electrode according to a state of charge (SOC), Li⁺ transport in the Li-CMC electrode is greatly promoted, which is due to a high population of adsorbed molecules of lithiated graphite phases near a bottom surface. In addition, it can be seen that the severe internal resistance resulting from an inert binder interfering with inter-particle diffusion may be significantly mitigated using Li-CMC.

In addition, the Li-CMC electrode exhibited a higher volumetric capacity than that of the composite electrode at a high C-rate (1 C) and 60° C., and this result ensures that the electrolyte-free electrode may provide an excellent opportunity to evaluate the important role of the ion-conducting binder in creating continuous interfaces when used in the ASSB, and through this, the development of promising binder materials for implementing a high-performance ASSB electrode may be promoted.

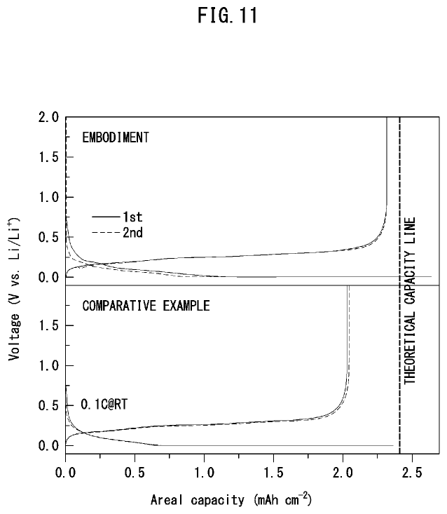

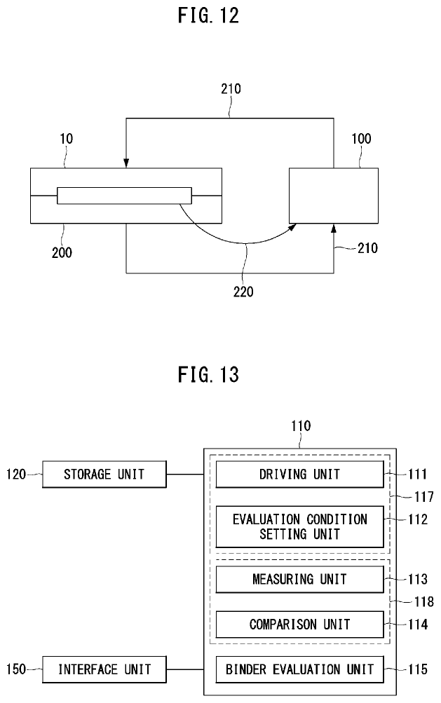

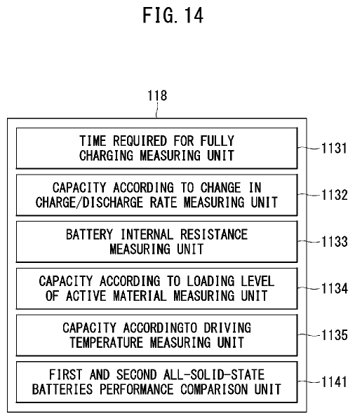

FIG. 12 is a schematic block diagram of an ion-conducting binder evaluation system for a secondary battery according to another exemplary embodiment of the present disclosure, FIG. 13 is a block diagram of a main configuration of the ion-conducting binder evaluation system of FIG. 12, and FIG. 14 is a detailed block diagram of a partial configuration of the ion-conducting binder evaluation system of FIG. 13.

Referring to FIGS. 12 to 14, in order to effectively evaluate the performance of an ion-conducting binder for a secondary battery, an ion-conducting binder evaluation system 100 may include a processor 110, a storage unit 120, and an interface unit 150.

The processor 110 may execute a program command stored in at least one of a memory and the storage unit 120. The processor 110 may refer to a central processing unit (CPU), a graphics processing unit (GPU), or a dedicated processor in which methods according to exemplary embodiments the present disclosure are performed. Each of the memory and the storage unit 120 may be configured with at least one of a volatile storage medium and a non-volatile storage medium. For example, the memory or the storage unit 120 may be configured with at least one of a read-only memory (ROM) and a random-access memory (RAM). In addition, the interface unit 150 may include an internal interface and an external interface, and the external interface may include an input/output interface and a communication interface.

Further, a driving unit 111, an evaluation condition setting unit 112, and a measuring unit 113 may be mounted in the processor 110.

The driving unit 111 applies a signal 210 for performance evaluation to a first all-solid-state battery 10 located at a predetermined position of evaluation system hardware such as a test bed 200. Here, the first all-solid-state battery 10 includes a first electrode composition including an electrode active material and an ion-conducting binder, a counter electrode disposed to face a first electrode formed of the first electrode composition, and a solid electrolyte layer between the first electrode and the counter electrode.

The evaluation condition setting unit 112 adjusts an evaluation condition for an environment, which is provided to the first all-solid-state battery 10, through the signal applied to the first all-solid-state battery 10 from the driving unit 111 or the evaluation system hardware. The environment may include an applied voltage, an applied current, a driving temperature, a charge/discharge rate, and the like.

The driving unit 111 and the evaluation condition setting unit 112 may be installed by being integrated into a single test module 117. The single test module 117 may form a part of the program commands that are loaded on the processor 110.

The measuring unit 113 is connected to the first all-solid-state battery 10 and measures the electrochemical and battery characteristics of the first all-solid-state battery 10 according to the evaluation condition. The measuring unit 113 may measure a voltage, current, a charge capacity, an internal resistance, a sheet resistance, a charging time, a temperature, and the like from the first all-solid-state battery 10 or the test bed 200.

Further, in the ion-conducting binder evaluation system 100 of the present exemplary embodiment, a second all-solid-state battery may be installed at a predetermined position of the evaluation system hardware such as the test bed 200 or another test bed that is substantially the same as the test bed 200, and the electrochemical characteristics and performance of the second all-solid-state battery may be evaluated. The second all-solid-state battery may include a second electrode composition composed of an electrode active material and a non-ion-conducting binder, a counter electrode disposed to face a second electrode formed of the second electrode composition, and a solid electrolyte layer between the second electrode and the counter electrode.

To this end, the driving unit 111 mounted in the processor 110 may apply a signal for evaluating the performance of the second all-solid-state battery to the second all-solid-state battery, and the measuring unit 113 may be connected to the second all-solid-state battery or the test bed and may measure the electrochemical and battery characteristics of the second all-solid-state battery according to the evaluation condition.

Further, the ion-conducting binder evaluation system 100 of the present exemplary embodiment may further include a comparison unit 114 that is a component mounted in the processor 110 and compares the electrochemical characteristics and battery characteristics of each of the first all-solid-state battery and the second all-solid-state battery on the basis of measurement information 220 or measurement results of the measuring unit 113.

The measurement information 220 or the measurement results may include at least one piece of information selected from among the time required for fully charging, charge capacity according to a change in charge/discharge rate, internal resistance of the all-solid-state battery, charge capacity according to an electrode active material loading level, and charge capacity according to driving temperature for each of the first all-solid-state battery and the second all-solid-state battery.

The above-described measuring unit 113 and comparison unit 114 may be installed by being integrated into a single battery evaluation module 118. The battery evaluation module 118 may be a part of the program commands that are loaded on the processor 110.

As shown in FIG. 14, as detailed components of the above-described measuring unit 113, the battery evaluation module 118 may include a time required for fully-charging measuring unit 1131, a capacity according to a change in charge/discharge rate measuring unit 1132, a battery internal resistance measuring unit 1133, a capacity according to loading level of active-material measuring unit 1134, and a capacity according to driving temperature measuring unit 1135. In addition, as a detailed component of the above-described comparison unit 114, the battery evaluation module 118 may include a first and second all-solid-state batteries performance comparison unit 1141. Each of the detailed components may be configured to perform a corresponding function, as indicated by its name.

Referring to FIGS. 12 and 13 again, as another component mounted in the processor 110, the ion-conducting binder evaluation system 100 of the present exemplary embodiment may further include a binder evaluation unit 115 configured to evaluate the performance of the ion-conducting binder on the basis of comparison results of the comparison unit 114. The binder evaluation unit 115 may be configured to evaluate the electrochemical characteristics and battery characteristics of the second all-solid-state battery, particularly the relative performance of the ion-conducting binder in the electrode of the battery on the basis of the electrochemical characteristics and the battery characteristics of the second all-solid-state battery, in particular, the performance of the non-ion-conducting binder in the electrode of the battery. The binder evaluation unit 115 may be a single binder evaluation module and may be a part of the program commands loaded on the processor 110.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An all-solid-state battery for an ion-conducting binder evaluation system for a secondary battery, the all-solid-state battery comprising:
an electrode manufactured with an electrode composition, which includes electrode active materials and a binder, so that ion transport in the electrode is dependent on a mechanism of ion diffusion between the electrode active materials by excluding an electrolyte component from the electrode;
a counter electrode disposed to face the electrode; and
a solid electrolyte layer disposed between the electrode and the counter electrode,
wherein a pore density of the electrode, which is an electrolyte-free electrode, is less than or equal to 15% of an electrode bulk density.

2. The all-solid-state battery of claim 1, wherein the binder includes an ion-conducting binder or a non-ion-conducting binder.

3. The all-solid-state battery of claim 2, wherein the ion-conducting binder includes an ion-conducting component and a functional group in a polymer structure.

4. The all-solid-state battery of claim 2, wherein the ion transport in the electrode is performed through a diffusion path through contact between the electrode active materials, and an additional path through the ion-conducting binder,
wherein the additional path is generated by the ion-conducting binder.

5. The all-solid-state battery of claim 2, wherein
a material of the electrode active material includes one selected from a negative electrode material coated with an electron-conducting layer, including graphite, hard carbon, soft carbon, a carbon nanotube, graphene, redox graphene, a carbon fiber, amorphous carbon, a silicon-carbon composite (SiC), or a carbon layer, and a mixed composition thereof, and
an electron conductivity of the electrode active material is greater than or equal to 2 S/cm.

6. The all-solid-state battery of claim 2, wherein a composition ratio of the electrode active material and the binder is selected in a range from 90:10 to 99.5:0.5 on the basis of a weight ratio.

7. A method of evaluating an ion-conducting binder for a secondary battery, which is performed by an ion-conducting binder evaluation system, the method comprising:
disposing a first all-solid-state battery, which includes a first electrode manufactured with a first electrode composition including an electrode active material and an ion-conducting binder, a counter electrode disposed to face the first electrode, and a solid electrolyte layer disposed between the first electrode and the counter electrode, at a specific position in the evaluation system;
setting an evaluation condition for a signal applied to the first all-solid-state battery or a provided environment; and
measuring electrochemical and battery characteristics of the first all-solid-state battery according to the evaluation condition.

8. The method of claim 7, further comprising:
disposing a second all-solid-state battery, which includes a second electrode manufactured with a second electrode composition including the electrode active material and a non-ion-conducting binder, a counter electrode disposed to face the second electrode, and a solid electrolyte layer disposed between the second electrode and the counter electrode, at a specific position in the evaluation system; and
measuring electrochemical and battery characteristics of the second all-solid-state battery according to the evaluation condition.

9. The method of claim 8, further comprising evaluating the performance of the ion-conducting binder by comparing the electrochemical and battery characteristics of each of the first all-solid-state battery and the second all-solid-state battery.

10. The method of claim 9, wherein, in the evaluating of the performance of the ion-conducting binder, the relative performance of the ion-conducting binder is evaluated on the basis of one from among a comparison of the time required for fully charging, a comparison of charge capacity according to a change in charge/discharge rate, a comparison of internal resistance of the all-solid-state battery, a comparison of charge capacity according to an electrode active material loading level, and a comparison of charge capacity according to driving temperature.

11. The method of claim 10, wherein the measuring of the electrochemical and battery characteristics includes measuring the time required for fully charging,
wherein the measuring of the time required for fully charging is performed in the order of constant current-constant voltage (CC-CV) mode charging and CC mode discharging, wherein a maximum lithium intercalation behavior is induced by setting a charge/discharge voltage to a range of 0.01 V to 2 V and a cut-off current during the CC-CV mode charging at a predetermined temperature to a value between 1/5 and 1/10.

12. The method of claim 10, wherein the measuring of the electrochemical and battery characteristics includes measuring the charge capacity according to the change in charge/discharge rate,
wherein, in the measuring of the charge capacity according to the change in charge/discharge rate, the charge/discharge rate of CC-CV mode charging is adjusted to 0.05 C to 10 C.

13. The method of claim 10, wherein the measuring of the electrochemical and battery characteristics includes measuring the internal resistance of the all-solid-state battery,
wherein, in the measuring of the internal resistance, a surface resistivity inside an all-solid-state battery cell at a specific temperature is measured while applying an alternating current (AC) impedance in a range of 10⁻¹ Hz to 10⁵ Hz using a frequency response analyzer.

14. The method of claim 10, wherein the measuring of the electrochemical and battery characteristics includes measuring the charge capacity according to the electrode active material loading level,
wherein, in the measuring of the charge capacity according to the electrode active material loading level, a maximum charge amount and a capacity implementation rate of the electrode are measured while adjusting the active material loading level of the electrode within 2 to 20 mg/cm².

15. The method of claim 10, wherein the measuring of the electrochemical and battery characteristics includes measuring the charge capacity according to the driving temperature,
wherein, the measuring of the charge capacity according to the driving temperature is performed by setting a cut-off current to 1/10 while controlling a charging rate to 0.1 C to 1 C through CC-CV mode charging and CC mode discharging at 0.01 V to 2 V.

16. The method of claim 7, wherein the ion-conducting binder is one selected from among a poly(3,4-ethylenedioxythiophene):poly(styrene sulfonate) (PEDOT:PSS)-based multi-component binder, lithium polyacrylate (LiPAA), and lithium carboxymethyl cellulose (Li-CMC), or a combination thereof, and
a material of the electrode active material includes one selected from a negative electrode material coated with an electron-conducting layer, including graphite, hard carbon, soft carbon, a carbon nanotube, graphene, redox graphene, a carbon fiber, amorphous carbon, a silicon-carbon composite (SiC), or a carbon layer, and a mixed composition thereof.

17. An ion-conducting binder evaluation system configured to evaluate the performance of an ion-conducting binder for a secondary battery, the ion-conducting binder evaluation system comprising:
a driving unit configured to apply a signal for performance evaluation to a first all-solid-state battery located at a predetermined position of evaluation system hardware, wherein the first all-solid-state battery includes a first electrode composition composed of an electrode active material and an ion-conducting binder, a counter electrode disposed to face a first electrode formed of the first electrode composition, and a solid electrolyte layer between the first electrode and the counter electrode;
an evaluation condition setting unit configured to adjust an evaluation condition for an environment provided to the first all-solid-state battery through a signal applied to the first all-solid-state battery or the evaluation system hardware from the driving unit; and
a measuring unit connected to the first all-solid-state battery and configured to measure electrochemical and battery characteristics of the first all-solid-state battery according to the evaluation condition.

18. The ion-conducting binder evaluation system of claim 17, wherein
the driving unit applies a signal for performance evaluation to a second all-solid-state battery located at a predetermined position of the evaluation system hardware,
the second all-solid-state battery includes a second electrode composition composed of the electrode active material and a non-ion-conducting binder, a counter electrode disposed to face a second electrode formed of the second electrode composition, and a solid electrolyte layer between the second electrode and the counter electrode, and
the measuring unit is connected to the second all-solid-state battery and measures electrochemical and battery characteristics of the second all-solid-state battery according to the evaluation condition.

19. The ion-conducting binder evaluation system of claim 18, further comprising a comparison unit configured to compare the electrochemical and battery characteristics of each of the first all-solid-state battery and the second all-solid-state battery on the basis of measurement information of the measuring unit,
wherein the measurement information includes at least one piece of information selected from among the time required for fully charging, charge capacity according to a change in charge/discharge rate, internal resistance of the all-solid-state battery, charge capacity according to an electrode active material loading level, and charge capacity according to driving temperature for each of the first all-solid-state battery and the second all-solid-state battery.

20. The ion-conducting binder evaluation system of claim 19, further comprising a binder evaluation unit configured to evaluate the performance of the ion-conducting binder on the basis of a comparison result of the comparison unit.
